(19) United States
(12) Patent Application Publication
(10) Pub. No.: US 2009/0057634 A1
(43) Pub. Date: Mar. 5, 2009

(54) RV stabilizer system

(76) Inventor: Barciliso Jerry Giralde, Fresno, CA (US)

Correspondence Address: BARCILISO JERRY GIRALDE, 3212 WEST FLORADORA AVENUE, FRESNO, CA, 93722, US

(21) Appl. No.: 11/897,423

(22) Filed: Aug. 30, 2007

(51) Int. Cl. B60S 9/06

(52) U.S. Cl. 254/424

(57) ABSTRACT

A stabilizer mechanism and stabilizer system for securement to the underside of fifth-wheel trailers, trailers or the like. The important feature of this invention is a stabilizer mechanism where the upper mounting bracket and lower foot bracket are off center. The stabilizer by itself would lean to one direction. The stabilizer is to be used in pairs with each placed as to lean in the direction of the other. The heavier the load the more stabilizing effect is applied.

### BACKGROUND OF THE INVENTION

The present invention relates generally to structural stabilizing mechanisms and systems of stabilizing fifth-wheel trailers, trailers, or the like. More specifically, this invention relates to lateral and vertical stabilizing to reduce or prevent swaying of the vehicle while in stationary use.
1. Screw operated scissor jacks have long been known to be used as stabilizers for fifth-wheel trailers, trailers or the like. The scissor jack provides vertical lift with limited lateral stabilization. There are many apparatus on the market to attempt to solve the swaying while in stationary use.
2. U.S. Pat. No. 5,205,586 shows a stabilizer assembly that is mounted under the bottom of the rear of the trailer. A single member is movable downward on each side of the trailer, independent of the other member.
3. U.S. Pat. No. 5,755,430 discloses leveling legs that extend downward from the front of the trailer to support the trailer on non-level surfaces.
4. U.S. Pat. No. 6,095,474 discloses leveling legs that extend downward pulled together by some means of force.
5. U.S. Pat. No. 6,331,016 shows a pair of supports extending to the scissor jacks that are widely used at present. This invention requires a slide rail in which the jacks would slide.
6. U.S. Pat. No. 6,572,251 shows a scissor jack design with a double lead acme screw. While the double acme screw gives a faster lift and better braking capabilities, it is of less desire when lifting heavy objects such as fifth-wheel trailers, trailers or the like by a hand crank. It is a vertical scissor jack with limited lateral stabilization.

While the foregoing patents generally describe apparatuses, a system that generally provide some benefits for stabilizing a fifth-wheel trailer, trailer or the like, they have not solved the problem of lateral stabilization. What is needed is a stabilizing apparatus that will stabilizes the lateral movement of a fifth-wheel trailer, trailer or the like.

### SUMMARY OF THE INVENTION

The invention is a stabilizer mechanism and stabilizer system for fifth-wheel trailers, trailers or the like. The mechanism is secured to the underside of each side of the vehicle, centering the load, stabilizing vertical and lateral movement.

The technical advance represented by the invention as well as the objects thereof will become apparent from the following description of the preferred embodiment of the invention when considered in conjunction with the drawings, and the novel features set forth in the appended claims.

The invention solves the problem of unwanted lateral and vertical movements while the vehicle in stationary use.

### BRIEF DESCRIPTION OF THE DRAWINGS

FIG. 1 is a perspective view of a stabilizer mechanism of the present invention in a raised condition.

FIG. 2 is a side view of a stabilizer mechanism of the present invention in a raised condition.

FIG. 3 is a rear view of fifth-wheel trailer, trailer, vehicle or the like showing a pair of the stabilizer mechanism, configured according to a preferred embodiment of the present invention creating a RV stabilizer system.

### DETAILED DESCRIPTION

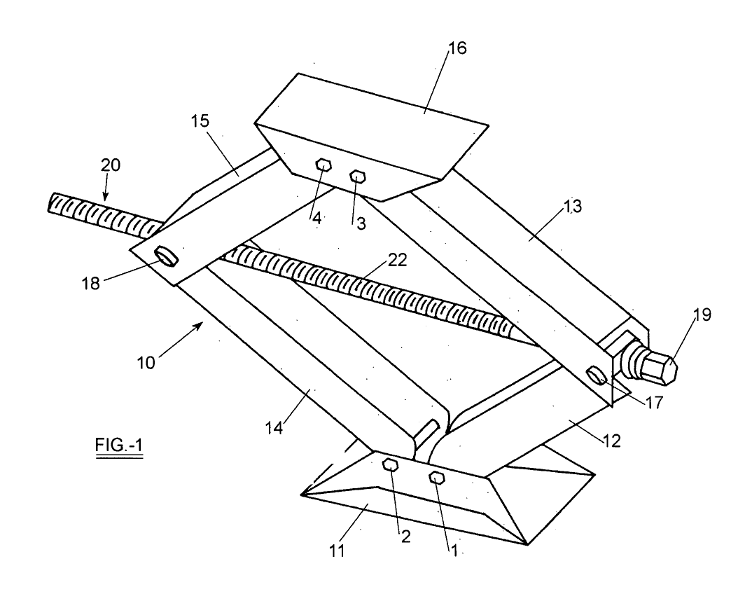

A screw-operated stabilizer mechanism in accordance with a preferred embodiment of the present invention is indicated generally in FIG. 1 by the reference numeral 10.

The stabilizer mechanism 10 is comprised of a foot pad member 11 employed for resting against a flat, stationary surface such as the ground, pavement, concrete floor or some other relatively firm material;

a first movable arm member 12 rotatably connected at a first of its two ends to the base member 11 by a first bolt 1;

a second movable are member 13 rotatably connected by a first trunnion 17 at a first of its two ends to the second end of the first movable are member 12;

a third moveable are member 14 rotatably connected at a first of its two ends to the base member 11 by a second bolt 2;

a fourth moveable arm member 15 rotatably connected by a second trunnion 18 at a first of its two ends to the second end of the third moveable arm member 14;

The load mounting bracket 16 center and the foot pad 11 center are offset when assembled. This is created by arm member 12 being shorter in length than the opposing arm member 14 and arm member 13 lengths the same as arm member 14 and shorter than arm member 15 and arm member 15 being the same length as arm member 12.

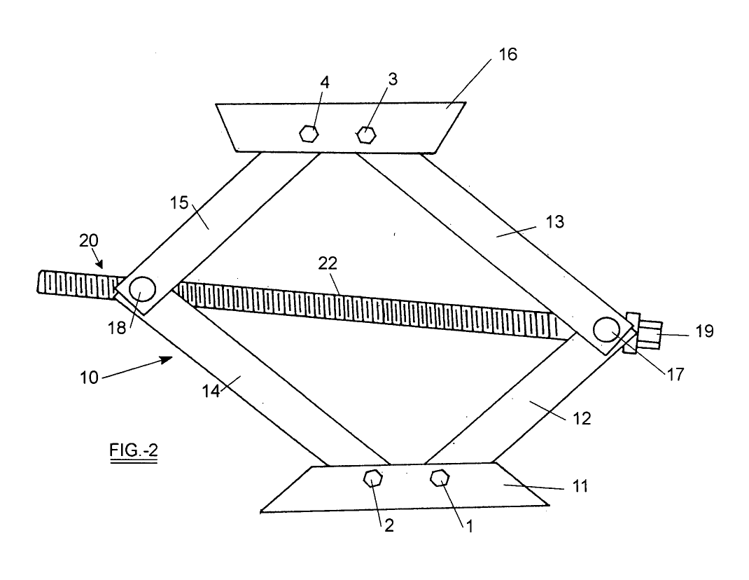

A load mounting bracket 16 being connected by bolts 3 and 4 (the bolts 4 shown in FIG. 2) to the second ends of the second and the forth movable arm member 13 and 15 in a manner so that the second and fourth arm members 13 and 15 are rotatable in relation to the load mounting bracket 16.

The stabilizer assembly 10 is further comprised of a horizontally extending, rotatable shaft member indicated generally by the numeral 20 in FIG. 1 and FIG. 2.

The rotatable shaft member 20 is provided a thread 22 that continuously extends from one end of the shaft member 20 and across approximately to the other end; and a turning means generally indicated in the drawings by the reference numeral 19 and situated on the end of the shaft member 20.

Each of the trunnions 17 and 18 are provided with a bore that extends perpendicularly through the center portion of the turnings 17 and 18. In the case of the trunnion 17, the bore provided therethrough is unthreaded and is slightly larger than the diameter of the threaded shaft member 20. In the case of the trunnion 18, the provided bore is threaded that is dimensionally compatible with the threading provided on the shaft member 20.

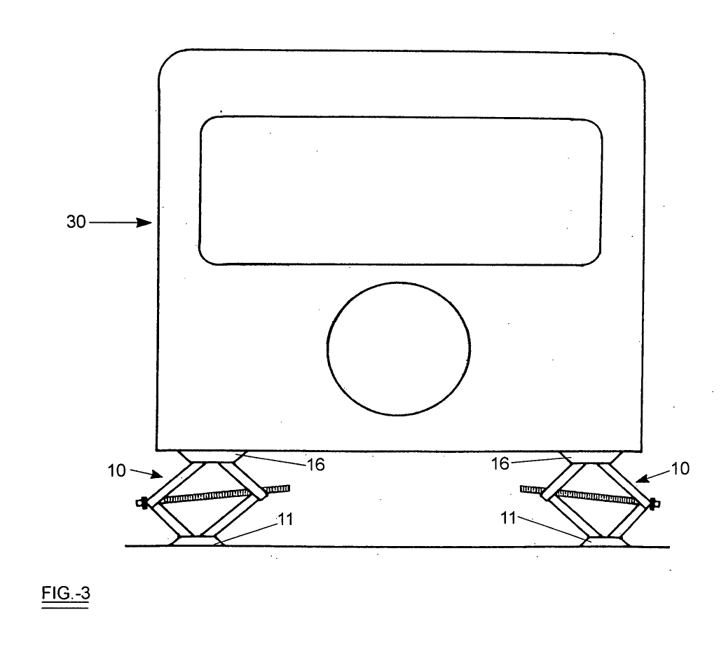

FIG. 3 illustrates the preferred embodiments with two stabilizer mechanisms mounted on the under side of the vehicle, one toward each side of the vehicle. The upper mounting bracket 16 being closed to the center of the vehicle and the foot bracket 11 being closest to outer side of the vehicle.

In operation, the stabilizer mechanism 10 will cause the foot pad 11 to be lowered to the ground. As force increases vertical a lateral force will be created at the upper load mount 16.

An opposing stabilizer mechanism with the same lateral force inward to the other stabilizer mechanism would cancel out any movement.

The more force applied to the two stabilizer mechanisms the more stabilizing affect is applied.

While there are shown and described herein a specific form of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to any dimensional relationships set forth herein and modifications in assembly, materials, size, shape and use. For instance, there are numerous components described herein that can be replaced with equivalent functioning components to accomplish the off-centering of the upper mounting bracket and the lower foot bracket accomplishing one of the objectives of the present invention.

What is claimed is:

1. A RV stabilizer system for a fifth-wheel trailer, trailer or the like, comprising:
a pair of stabilizer mechanisms attached to the underside of each side of the trailer.
wherein each of said pair of stabilizer mechanisms include a upper mounting bracket and a lower foot base bracket that are off center.

2. The RV stabilizer system according to claim 1, including a stabilizer mechanism for raising or lowering each pair of stabilizer mechanisms independent of each other.

3. The stabilizer mechanism according to claim 2, including a foot base bracket and a upper mounting bracket that are off center when assembled to arms of unequal lengths.

4. The stabilizer mechanism according to claim 2, including two upper arms of unequal length pivotally secured at their upper ends at the upper mounting bracket.

5. The stabilizer mechanism according to claim 2, including two lower arms of unequal lengths pivotally secured at their lower ends at the foot base bracket.

6. The stabilizer mechanism according to claim 2, including the upper arms connect to lower arms by two trunnions.

7. The stabilizer mechanism according to claim 2, including the first trunnion is threaded and the second is a straight bore.

8. The stabilizer mechanism according to claim 2, including a rotatable shaft member extending through bores in said first and second trunnions.
